(19) United States
(12) Patent Application Publication
(10) Pub. No.: US 2010/0161303 A1
(43) Pub. Date: Jun. 24, 2010

(54) METHOD, SYSTEM, COMPUTER PROGRAM PRODUCT, AND USER INTERFACE FOR PERFORMING POWER INFERENCE

(75) Inventors: Miles P. McGowan, Campbell, CA (US); Joseph P. Jarosz, Sunnyvale, CA (US); Thaddeus Clay McCracken, Portland, OR (US)

Correspondence Address: VISTA IP LAW GROUP LLP, 1885 Lundy Avenue, Suite 108, SAN JOSE, CA, 95131, US

(73) Assignee: CADENCE DESIGN SYSTEMS, INC., San Jose, CA (US)

(21) Appl. No.: 12/342,012

(22) Filed: Dec. 22, 2008

(51) Int. Cl. G06G 7/62; G06F 17/50

(52) U.S. Cl. 703/13

(57) ABSTRACT

An improved method, system, user interface, and computer program product is described for performing power-related inferences for an electronic design. According to some approaches, the electronic design is configured to include multiple power domains. Design information is used to infer the existence of power-management structures for and between the power domains in the electronic design. A graphical user interface is provided to visualize the inferred power-related structures and to allow the user to interact with and modify the design information related to power management.

### BACKGROUND

The invention relates to technology for designing and verifying an electronic design, such as an integrated circuit (“IC”) design.

Power management has become an important consideration during the process of designing an electronic device. In part, this is due to the rapid growth of products in the wireless and portable electronics markets, which has resulted in more and more functionality being incorporated into battery-operated products and therefore increasing the challenges for power management of such devices. Such challenges include minimization of leakage power dissipation, designing efficient packaging and cooling systems for power-hungry IC's, or verification of functionality or power shut-off sequences early in the design. These challenges are expected to become even more difficult with the continuous shrinking of process nodes using today's CMOS technology. Managing design and verification for power will be as critical as timing/area in today's IC design flow for portable consumer electronics.

Modern electronic design is typically performed with computer aided design (CAD) tools or electronic design automation (EDA) systems. To design an integrated circuit, a designer first creates high level behavior descriptions of the IC device using a high-level hardware design language (HDL). Common examples of HDLs include Verilog and VHDL. An EDA system typically receives the high level behavior descriptions of the IC device and translates this high-level design language into netlists of various levels of abstraction. Essentially, the process to implement an electronic device begins with functional design and verification (e.g., using RTL), and then proceeds to physical design and verification.

The planning and design of power management components in an electronic design is typically performed by a power management expert, where the specification for the power components is set forth in complex and very detailed file formats, such as the standard CPF common power format (CPF), the details of which are available from www.si2.org. The CPF file is used as the template by an EDA tool to implement a circuit design having the required power management structures. However, power planning and management are tasks that often need to be performed by personnel that are not experts in the power domain and do not have extensive expertise with CPF-like power formats or power structure design. For example, high-level architects and early stage chip planners may need to be able to perform product and design analysis based upon the inclusion of power management structures, but are often not themselves experts in the design and implementation of power structures.

In addition, the various structures in an electronic design to perform power management are traditionally included very late in the design cycle, by a physical design engineer when implementing a physical design for the electronic product. This approach has two significant flaws. First, the inclusion of these additional structures at the late-stage physical design time does not allow early stage chip planners and architects to be able to use these structures to obtain accurate estimates of the electronic product, such as estimates of the power, leakage, and die size for the product. Second, this approach assumes that the physical design engineer has knowledge and understanding of the “intent” behind the power management of the design.

### SUMMARY

Embodiments of the present invention provide an improved method, system, user interface, and computer program product for performing power-related management and design for electronic products. According to some embodiments, the electronic design is configured to include multiple power domains. Design information is used to infer the existence of power-management structures for and between the power domains in the electronic design. A graphical user interface is provided to visualize the inferred power-related structures and to allow the user to interact with and modify the design information related to power management. The invention greatly facilitates the efficient and accurate planning and visualization of power management for an electronic design, without requiring the user to be a power specialist.

Other additional objects, features, and advantages of the invention are described in the detailed description, figures, and claims.

### BRIEF DESCRIPTION OF FIGURES

FIG. 1 depicts an architecture of a system for performing power-related inferences according to some embodiments of the invention.

FIG. 2 illustrates a flow of an approach for performing power-related inferences according to some embodiments of the invention.

FIG. 3 illustrates a detailed flow of an approach for performing power-related inferences according to some embodiments of the invention.

FIG. 4A-E illustrate a graphical user interface for power-related inferences according to some embodiments of the invention.

FIG. 5 illustrates example operating modes.

FIG. 6 shows an architecture of an example computing system with which the invention may be implemented.

### DETAILED DESCRIPTION

Embodiments of the present invention provide an improved method, system, user interface, and computer program product for performing inference of power intent, components, and structures in an electronic design. The present invention permits this information to be inferred while the user is working at the architectural level. This will allow for more accurate estimations of power, leakage, and die size at a point in the design process where it can be useful. The present approach allows the power intent to be captured and passed forward to the physical designers of the electronic product. This provides numerous advantages, including the ability to allow for more accurate estimations without requiring the architect or executive that is using the tool to themselves be a power expert or guru.

According to some embodiments, the electronic design is configured to include multiple power domains. Design information is used to infer the existence of power-management structures for and between the power domains in the electronic design. A graphical user interface is provided to visualize the inferred power-related structures and to allow the user to interact with and modify the design information related to power management.

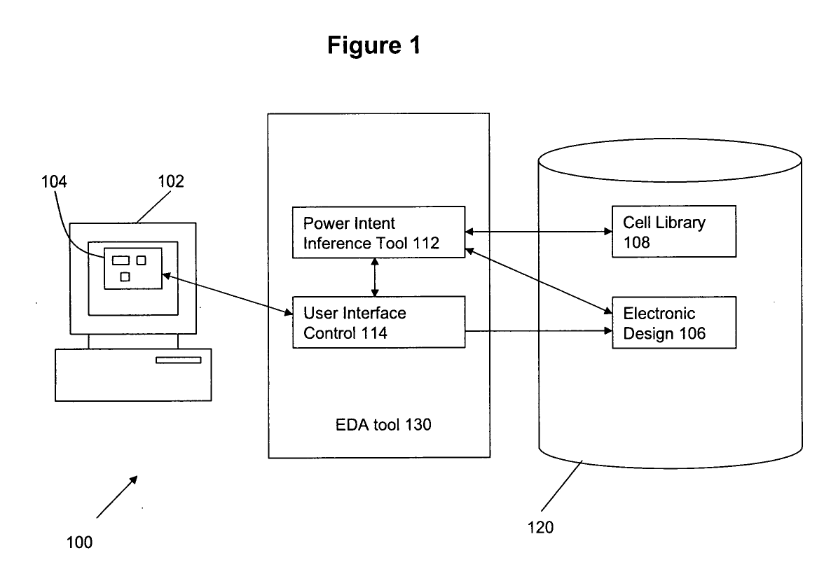

FIG. 1 shows an architecture of a system 100 for performing power intent inference according to one embodiment of the invention. The system 100 includes the power inference EDA tool 130 that is operated by one or more users at user station 102. The users at user station 102 correspond to any individual, organization, or other entity that uses system 100 for planning or designing an electronic design. The use stations 102 could be implemented using any suitable computing platform.

The power inference EDA tool 130 may be used for any number of reasons by the user at user station 102. For example, one possible purpose is to generate data to perform chip estimation/planning. The chip estimation/planning tasks allow an organization at a very early stage in the design cycle to plan, outline, and analyze the characteristics and production requirements of an electronic product. By analyzing the functional and physical requirements of the early stage electronic design, the chip estimator/planner provides users with analysis results that could include an estimate of the chip size, power, leakage and cost of the final electronic product. The analysis results provide the users of the chip estimator/planner, such as IC design teams, system architects and management, with the ability to visualize tradeoffs throughout the chip design flow. By bringing IP and manufacturing data to bear on the earliest stage of chip planning, the chip planner enables earlier and more informed decision-making in the context of critical decisions affecting chip performance, functionality and cost. The chip planner helps design teams explore a wide range of chip architecture options in literally seconds including selection of IP, technology nodes and processes, power optimization strategies, packaging and much more. An exemplary chip planner is available from Cadence Design Systems, of San Jose, Calif., with further information available at the following websites: www.chipestimate.com or www.cadence.com.

The user station 102 may be associated with one or more databases 120 or other computer readable medium that holds data regarding the user's electronic design 106. The electronic design 106 comprises any set of information or parameters that the user has developed to determine the requirements or design details corresponding to the electronic design 106. The one or more databases 120 include a cell library 108 that stores information about the different cells/IP blocks that may be included in the electronic design 106. In particular, the cell library 108 comprises cells/blocks corresponding to power management structures such as level shifters, isolation cells, state retention cells, power switches, and other power-related components.

The user station 102 is implemented to include a graphical user interface 104. The graphical user interface 104 can be used to graphically display a representation of the electronic design 106 to the user. In addition, the graphical user interface allows the user to provide, update, and modify design details and parameters for the electronic design 106.

The process of performing power inference occurs in two phases according to some embodiments of the invention. The first phase is performed by the user at user station 102 to provide power-related design details for the electronic design 106. For example, consider an electronic design 106 that includes at least two power domains A and B. The user may configure the design to have the following power intent: “both domain A and B both can be completely shut off when their functionality is not needed.” Furthermore, the user may provide design details that consider tradeoffs such as, “What happens to power consumption if the operating voltage of a domain which is not temporally critical is lowered?”

These design details may be provided using the graphical user interface 104. The EDA tool 130 includes a user interface control 114 that receives data based upon manipulation of the user interface 104 and entry of data by the user at user station 102, which are used to update the electronic design 106.

The second phase is performed by the power intent inference tool 112. The power intent inference tool 112 uses the information provided by the user to makes design choices, which result in the inclusion or modification of power structures and components in the electronic design 106. The power structures and components may be implemented using cells and blocks from the cell library 108. The modified design therefore provides an early-stage design that takes into account the physical realities of what the user has expressed as his/her power intent.

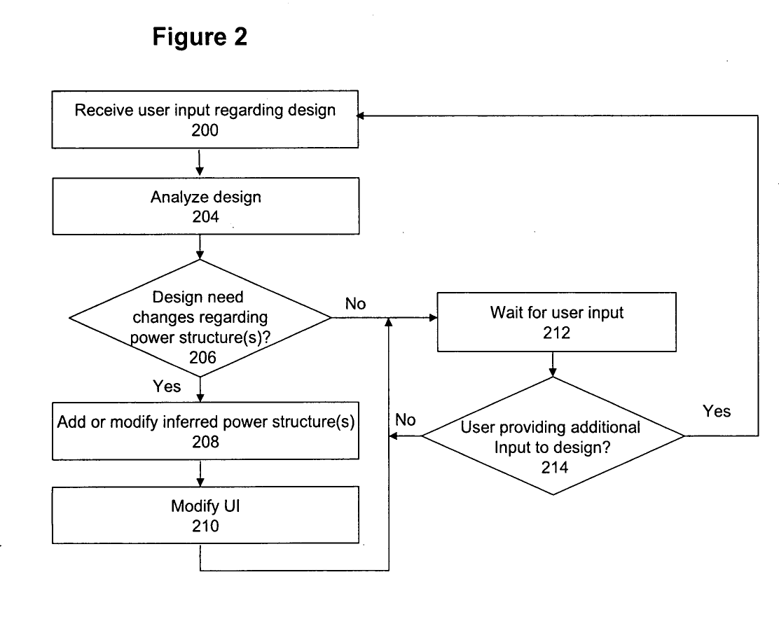

FIG. 2 shows a flowchart of a process for inferring power intent according to some embodiments of the invention. At 200, user input relating to power intent is received for the electronic design. The user input relates, for example, to different modes of operation for a design and their effects on power and leakage. The user can modify design parameters such as clock frequency and activity, as well as overriding those same parameters on a per instance basis. The user can also adjust the nominal voltage for a portion of the design along with the percentage of time that the design portion is turned off. The user input may be based upon changes by the user to already-inferred power structures being displayed in the user interface.

At 204, the design is analyzed to determine whether the user input corresponds to one or more changes that should be inferred for the power structure or management of the design. According to some embodiments, this analysis is performed based upon the concept of “power domains,” which are discrete portions of the design that will share common power attributes. By placing instances of the various IP and random logic within a power-domain, the user/design is expressing a physical requirement that those instances are to be physically placed together during physical implementation. This allows for the inference of a physical requirement from the architectural level power intent. In some embodiments, the present approach can also be taken with respect to blocks in the design.

When analyzing the power domains, design intentions are refined by creating rules that describe the power-related interactions and characteristics of the power domains. These rules are used to identify whether any additional power structures are needed to implement the design. Based upon these rules, a determination is made at 206 whether any changes need to be inferred with regard to the power-related structures in the electronic design. The inferred changes can include the addition of one or more new power-related structures to the design or the modification of existing power-related structures in the design. According to some embodiments, examples of power-related structures that may be inferred include isolation cells, level shifters, power switches, and state retention structures.

An isolation cell is a structure that provides power separation between different portions of a circuit. Isolation cells are useful to provide power-up and power-down separation between different modules in a circuit. For example, in a CMOS design, the isolation cell allows unneeded portions of the circuit to be powered down to reduce leakage current, thereby increasing he efficiency of power usage. According to some embodiments, rules for isolation cells will infer such isolation cells in the design if the user has enabled a power-domain to support power-shutoff (PSO).

A level shifter operates by increasing or decreasing voltage along a circuit path. According to some embodiments, level shifter rules will infer the need for level shifters by identifying the difference in operating voltages specified for the different power-domains in a project. This includes taking into account changes in voltages in the various power modes that may be defined for the project. In one embodiment, the user has control over whether or not to ignore low-to-high and/or high-to-low voltage differences.

According to some embodiments, the need for a power switch is inferred based on whether or not a power-domain is to be externally controlled. The number of power switch cells needed is based on the saturation current capabilities of the available switch cells in the chosen technology and the power consumption of the domain under its worse operating condition or mode. In one embodiment, the specific power switch cell to be used is based on the one which has the highest saturation-current-density, e.g., that has the highest ratio of saturation_current/cell_area, based on analysis of the cell library.

The state retention cell is a structure that maintains state when part or all of the circuit is powered down. According to some embodiments, state retention rules will infer the need for a state retention cell based on identifying whether or not a power-domain should support state retention and whether the power-domain also supports power-shutoff. The number of cells is based off a specified percentage of flip-flops.

According to some embodiments, the types of level shifter, isolation, and state retention cells are based on an area/timing priority, in which the smallest cell of the required type should be chosen. If area is a tie, then the cell with the highest drive strength wins, as long as the cell having higher drive strength does not correspond to significantly slower timing. One approach for selecting an appropriate cell is described in co-pending U.S. application Ser. No. ______, Attorney Docket No. 08PA108, entitled “METHOD AND SYSTEM FOR PERFORMING CELL MODELING AND SELECTION”, filed on even date herewith, which is hereby incorporated by reference in its entirety.

If any of these structures are to be inferred, then at 208 the inferred structures are added to the electronic design data. If the interference is based upon a modification to an existing structure, then the required modification is made to the portion of the electronic design data corresponding to the modified structure.

At 210, the user interface is modified to include a visual representation of the newly inferred structure or the modification to the newly modified structure. The user interface with the changed visual representation is then displayed to the user on a display device.

Based upon the displayed representation to the user, the user may decide to provide additional input with respect to the electronic design. Therefore, at 212, the system/process waits for additional user input. The user input may comprise graphical modifications to the design or to the newly added power-related cells using the graphical user interface. If additional user input is received at 214, then the process returns back to 200 to repeat the above-described actions.

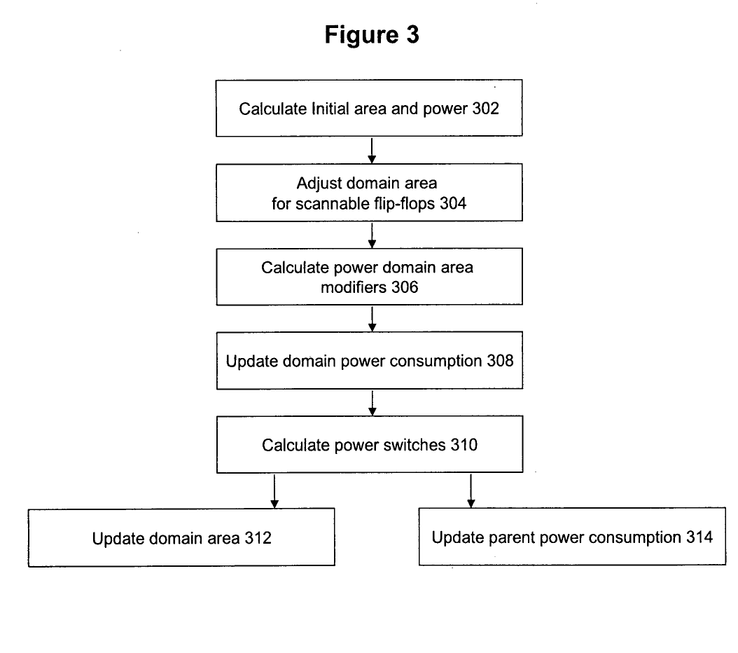

FIG. 3 shows a detailed flowchart of a process for performing power inference with respect to power domains according to one embodiment of the invention. At 302, a calculation is performed for the initial starting point for the area and power of the power domain. The domain area calculation is based on the assumption that the specified gate-count includes a combinatorial area and a sequential area, assuming the IP/random-logic is non-scannable. Power calculations are performed using lookup tables for cells in the cell library. Flip-flop counts are also based upon a frequency dependent lookup, or can be hard-codes based upon user preference.

There is the possibility that the power domain may operate at multiple active voltages. This case is more complicated, given that the required number of power switches should be based on the highest possible power consumption of the domain (amongst all the available modes, and voltages, at which it can operate). According to some embodiments, the following information is used to perform the estimation: (i) a list of voltages at which a domain can operate, as defined in the user-created power-modes for the chip, which could be a subset of the possible operating voltages for the domain, if some voltages end-up not being referenced in any defined power-mode; (ii) a power-lookup table (in the model) that specifies active power at each possible power-voltage-temperature (PVT); and (iii) leakage-power figures for each possible PVT. Iteration is then performed over each functional mode/voltage combination to calculate the worst-case power for the domain. This will be the starting point for power consumption for the domain.

At 304, the domain area is adjusted for any scannable flipflops. When the user makes a clock scannable, the area of any domains/blocks connected to that clock increase, and the scan overhead is reported. When a user specifies that a domain require any of the various advanced low-power techniques, estimation will be generally performed by performing an initial flip-flop count of the domain, where scan-overhead is added into the area of the domain.

At 306, calculations are performed for area modifiers for the power domain. For example, the logic area may be recalculated based upon the inference of level shifters, isolation cells, and state retention registers. The number of level shifter and/or isolation cells required inside a given domain is based on the following factors: (i) the number of domain inputs/outputs and (ii) isolation and level shifting rule attributes (e.g., from, to, and location attributes). The number of domain inputs and outputs can be tracked separately and may be explicitly defined by the user or calculated heuristically.

Turning the above information into an exact number of cells to be added to each domain is not an easy task, since rules can be specified such that cells would need to be placed in either the source or destination domain for both domain inputs and outputs. In addition, multiple rules can be defined from/to the same pair of domains, or from many domains into one domain, thus making it impossible or difficult to know exactly how many domain ports are associated with each rule.

The present approach according to one embodiment uses fractional division of domain inputs and outputs, based on the number of affected rules, to overcome this problem. The approach first calculates (e.g., separately) the number of level-shifting and isolation logic “operations” that are to be performed inside the domain, for both inputs and outputs. The following equation is used to calculate the number of inputs to isolate, for a particular domain:

$$num\_inputs \_to \_isolate = \frac{num\_inputs \times num\_iso \_rules ( to\_this \_domain , location = “ to ” )}{num\_iso \_rules ( to\_this \_domain )}$$

The following equation is used to calculate the number of outputs to isolate:

$$num\_outputs \_to \_isolate = \frac{\begin{matrix}num\_outputs \times \\ num\_iso \_rules ( from\_this \_domain , location = “ from ” )\end{matrix}}{num\_iso \_rules ( from\_this \_domain )}$$

The following equation is used to calculate the number of inputs to level shift:

$$num\_inputs \_to \_level \_shift = \frac{\begin{matrix}num\_inputs \times \\ num\_lvlshift \_rules ( to\_this \_domain , location = “ to ” )\end{matrix}}{num\_lvlshift \_rules ( to\_this \_domain )}$$

The following equation is used to calculate the number of outputs to level shift:

$$num\_outputs \_to \_level \_shift = \frac{\begin{matrix}num\_outputs \times \\ num\_lvlshift \_rules ( from\_this \_domain , location = “ from ” )\end{matrix}}{num\_lvlshift \_rules ( from\_this \_domain )}$$

Then, the number of cells to instantiate are calculated according to the below equations. The following equation is used to calculate the number of level shifter cells:

num_lvlshift_cells=num_inputs_to_level_shift+num_outputs_to_level_shift

The following equation is used to calculate the number of isolation cells:

num_iso_cells=num_inputs_to_isolate+num_outputs_to_isolate

The area associated with the level-shifting and/or isolation logic is then calculated as a function of the number of cells multiplied by the area of each cell type. In some embodiments, the approach will not initially account for the use of combination level-shifter/isolation cells in the estimation, but will rather estimate the cost of each function separately. In addition, there will be multiple level-shifter cell models (and thus area figures) available that correspond to: (i) level shifter for high-to-low shifting; (ii) level shifter for low-to-high shifting; and (iii) level shifter that is bi-directional (can be used in both L-H and H-L situations). The appropriate level-shifter (H->L or L->H) model will be used based on the type of shifting required. If a domain requires cells of both types, then it will be assumed that half the cells will be L->H, and the other half H->L.

Next, area calculations will be performed for state retention structures. According to the present embodiment, cells associated with state retention flip-flops and state retention flip-flops with scan will be considered for these calculations. Calculation of the number of state-retention flops will be based on the percentage of flip-flops that will be state-retained, e.g., by the user. This percentage is applied to the total number of flops in the domain order to determine the number of retention flops in the domain. The area of the domain is then increased according to the following equations:

num_retention_flops*(retention_scanflop_area−scan_flop_area)

This equation is used if the domain is scannable. If the domain is not scannable, then the following equation is used:

num_retention_flops*(retention_flop_area−flop_area)

At 308, an update is performed with respect to the domain power consumption. The purpose of this action is to incrementally adjust the power-consumption of a domain to reflect additional power consumed by isolation logic, level-shifting logic, and state-retention logic.

For the isolation logic, the power consumed by these elements is calculated by converting the isolation logic area to nand2-equivalent gates, with the active power updated accordingly. Isolation-related leakage can be based on the leakage figure attached to the cell type of the isolation logic.

For the level shifting logic, the level shifting logic area is also be converted to nand2 equivalents for the purpose of active power calculation. Leakage power can be based on the leakage figure contained in the corresponding level-shifter model.

In one embodiment, it is assumed that state-retention logic will not add any additional active power to the model. It is assumed that the main impact of these elements on power is the leakage-power contribution. For this leakage power contribution, the domain leakage power is updated by multiplying the number of each cell type by the leakage power figure for these cells from the cell library. It is noted that both on and off leakage should be considered, since leakage power may be consumed when the domain is either on or off.

At 310, a calculation is performed to determine the number of power switch structures to infer for the electronic design. Once the definition of the domain contents has been modified as described above, and the power-consumption of the domain has been updated to reflect power consumed by those elements, a calculation is performed to calculate the number of power switches that are used to power the domain, e.g., if the domain is a shutoff domain. The number of switches required for a domain can be determined based upon the following equation:

Num_switches=domain_current/switch_saturation−current

The domain area can then be updated to include the area of the power switches at 312. The area of the power switches is determined as a function of the number of power switches multiplied by the area of each power switch.

At 314, the power consumption determination is updated, where the final domain power-consumption update will include the leakage power consumed by the power switches that have been added to the domain. It is noted that this power does not require iterative calculation of the number of switches in the domain, since leakage of switches is consumed by the parent (supply) domain, and not by the switches themselves.

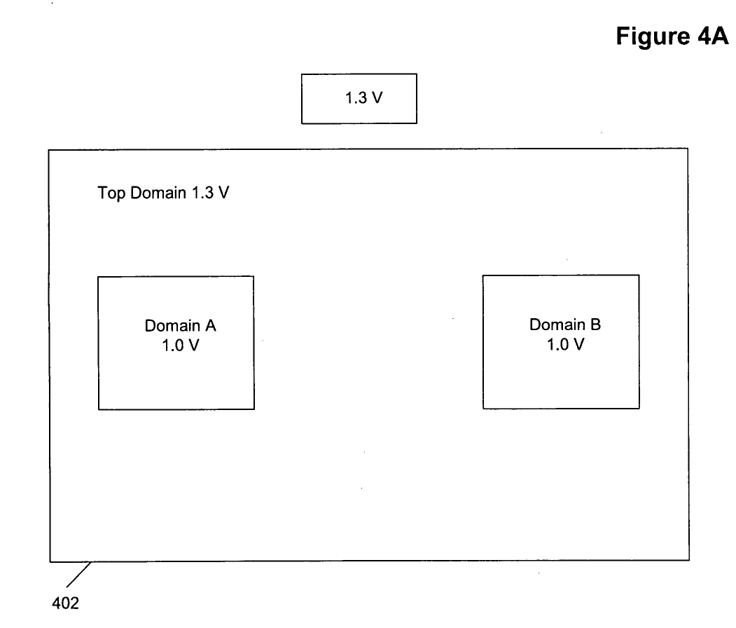

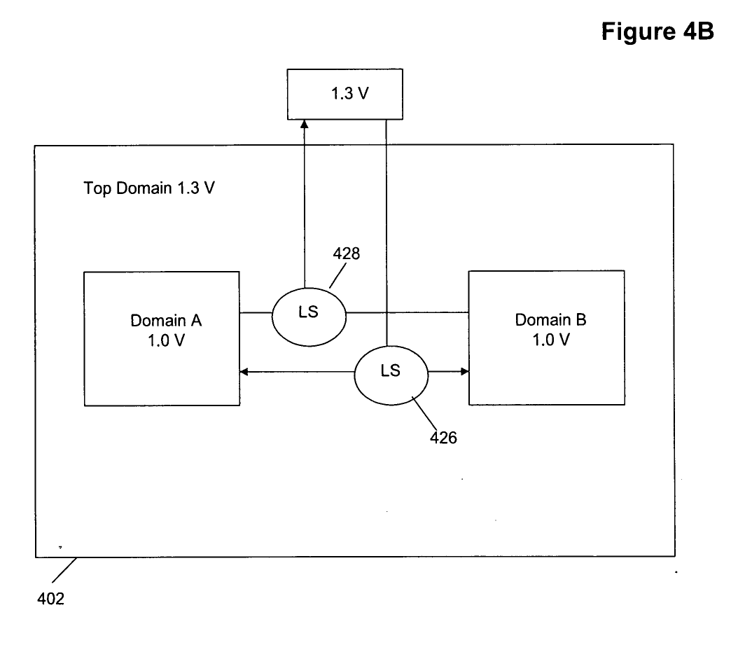

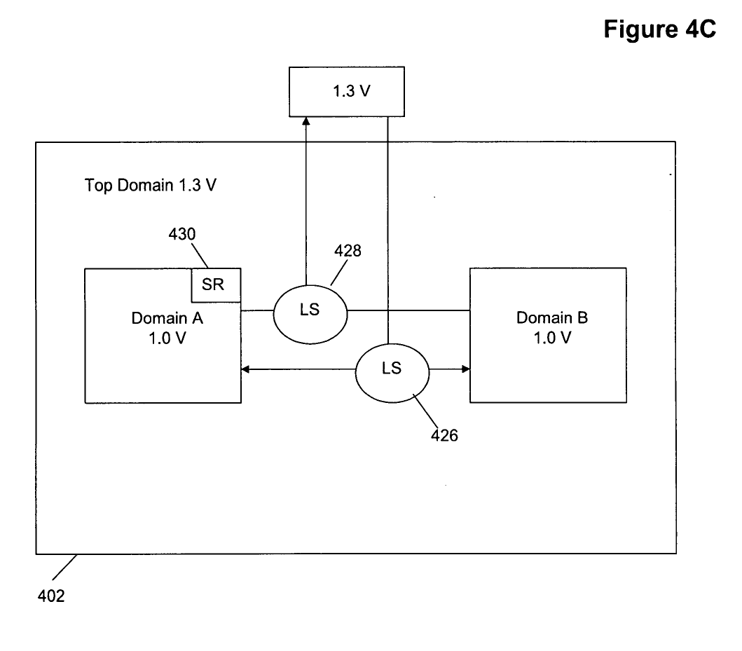

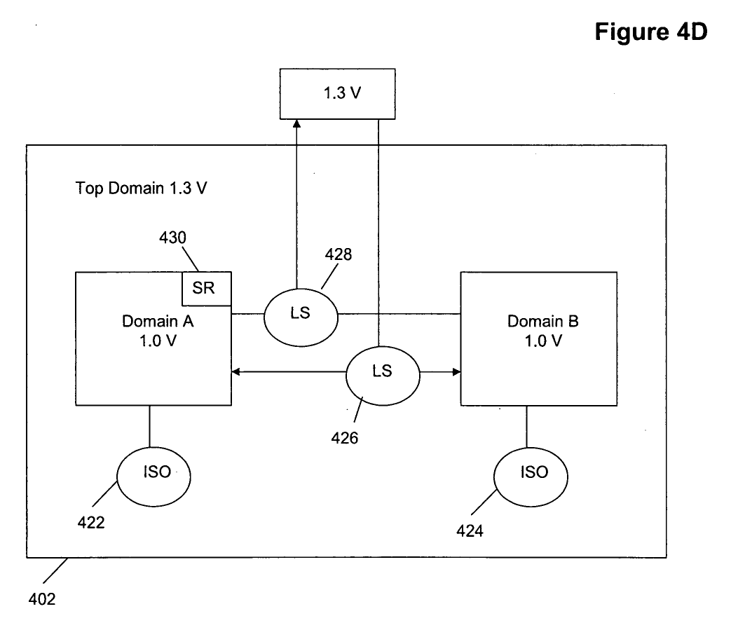

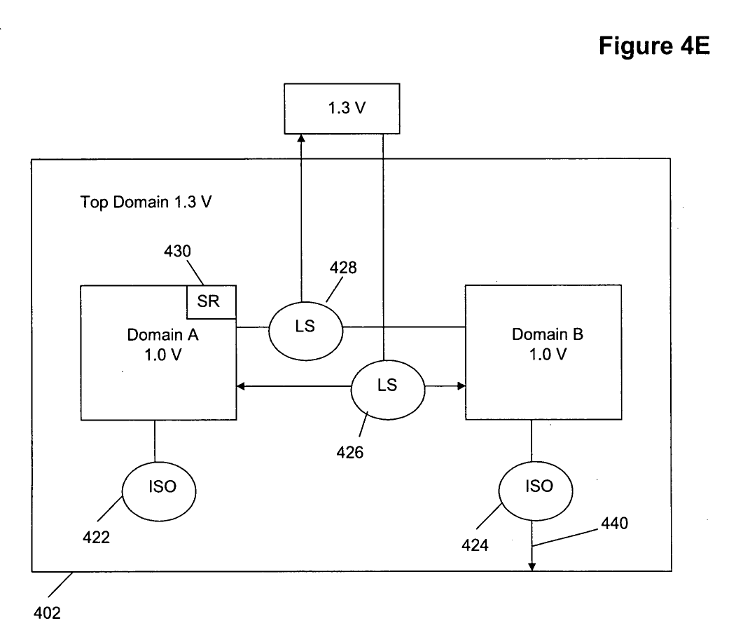

FIGS. 4A-4E illustrate an example representation of a graphical user interface according to some embodiments of the invention. This embodiment of a user interface is useful for architects and engineers to work with the power structures within an electronic design in a highly usable way that abstracts away the specific underlying details of the design. This allows the user to easily visualize and manipulate the design with respect to power management without requiring the user to possess highly specialized knowledge regarding power management and power management structures.

The user interface represents the different portions of the electronic design using multiple power domains. For example, FIG. 4A shows an electronic design 402 having three different power domains, including the Top Domain, a Domain A, and a Domain B. The Top Domain is the parent domain t both Domain A and Domain B.

Assume that the electronic design 402 represented by FIG. 4A has been configured, e.g., by user input, such that the Top Domain operates at 1.3V while Domain A and Domain B both operate at 1.0V. A determination is made whether level shifters need to be inferred for the design. This is done by reviewing the level shifts that occur between each domain in the design 402, i.e., from Top to A, Top to B, A to Top, A to B, B to Top, and B to A. Rules are implemented to determine whether or not there is a high-to-low or low-to-high change from one domain to another. Here, it can be seen that a change in voltage occurs from Top to A, Top to B, A to Top, and B to Top. In this situation, and using the processes described above, it is clear that level shifters will need to be implemented to allow the domains to interact with each other at the different voltage levels.

FIG. 4B illustrates the inclusion of visual icons 426 and 428 for level shifter rules that are displayed in the user interface to visualize the inclusion of inferred level shifter cells in the electronic design 402. Level shifter rule 426 represents the inclusion of high-to-low level shifter(s) that shift from the 1.3V level of the Top Domain to the 1.0V levels of Domain A and Domain B. Similarly, level shifter rule 428 represents the inclusion of low-to-high level shifter(s) that shift from the 1.0V levels of Domain A and Domain B to the 1.3V level of the Top Domain.

It is noted that FIG. 4B shows two combined icons for the level shifting structure(s) used in the electronic design, even though separate level shifting rules may exist for the four high-to-low or low-to-high voltage changes between domains in the design. According to some embodiments, the visual indicators may display either separate icons or combined icons in this situation. Furthermore, the rules themselves may be combined and re-used if they correspond to the same or similar design circumstances. Alternatively, the internal representations may correspond to distinct rules, e.g., four distinct rules for FIG. 4B instead of two for the level shifters.

Further assume that Domain A is configured by the user such that it needs to retain an output value even after it is shut off. The reason for this is so that when Domain A is turned back on, there is no delay or ramp-up time to recalculate the output value of the domain that was present prior to the shut-off time.

FIG. 4C illustrates the inclusion of a visual representation 430 for a state retention rule that is displayed in the user interface in association with Domain A to visualize the inclusion of an inferred state retention cell/register in the electronic design 402. The visual representation 430 of the state retention rule immediately alerts the user to the presence of an inferred state retention structure that is included in the electronic design 402.

FIG. 4D shows the inclusion of icons 422 and 424 for isolation rules that are displayed in the user interface to visualize the inclusion of isolation cells for Domains A and B. The visual representation of icons 422 and 424 immediately alert the user to the presence of an inferred isolation cells in the electronic design 402 and their association with Domains A and B.

The visual nature of the graphical user interface provides two main advantages. First, the graphical user interface visually shows to the user the existence of inferred power management structures in the electronic design. Secondly, the user interface provides a visual way for the user to interact and modify the electronic design, and to provide additional input to clarify or modify the inferred power-related structures.

For example, consider the isolation cells that were inferred for Domains A and B as shown in FIG. 4D. In some cases, there may not yet exist enough connectivity information to describe the connectivity between the isolation cells in the electronic design. Hence FIG. 4D shows the existence of the inferred isolation cells, but do not provide any additional details regarding their connectivity other than their association with specific domains.

The user may interact with the user interface to graphically insert additional graphical elements to augment the information regarding the inferred isolation cells. As an example, FIG. 4E shows the inclusion of a line 440 from isolation cell 424. This line 440 may be added by the user into the displayed representation of the design 402 to indicate the connectivity of the isolation cell 424. This type of control given to the user permits the user to provide control and refinement to the inferred power management structures, without requiring specific programming knowledge of a power management language like CPF.

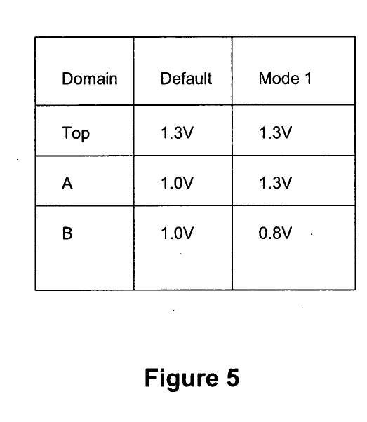

The power domains within an electronic design can be configured to have multiple operating modes. For example, consider the electronic design of FIG. 4A configured to have the modes shown in FIG. 5. The default mode for the various domains are as shown in FIG. 4A, where the Top Domain corresponds to 1.3V and both Domain A and Domain B correspond to 1.0V. However, in another operating mode (Mode 1), Domain A operates at the higher 1.3V level while Domain B operates at a lower 0.8V level.

In this situation, additional power management structures may need to be inferred. In particular, the different level shifts that occur between each domain for the different modes are considered in determining whether to infer power management structures, i.e., analysis for both modes from Top to A, Top to B, A to Top, A to B, B to Top, and B to A. Unlike the situation of FIG. 4B, additional level shifters may need to exist, e.g., between Domain A and Domain B since these two domains operate at different voltage levels in Mode 1. Rules are implemented to determine whether or not there is a high-to-low or low-to-high change from one domain to another. As previously noted, the visual indicators in the graphical user interface may display either separate icons or combined icons in this situation, where the displayed level shifter rules/icons may be combined or distinct. The rules themselves may be combined and re-used if they correspond to the same or similar design circumstances. Alternatively, the internal representations may correspond to distinct rules.

Therefore, what has been described is an improved approach for performing power-related inferences for an electronic design. The invention greatly facilitates the efficient and accurate planning and visualization of power management for an electronic design, without requiring the user to be a power specialist.

### System Architecture Overview

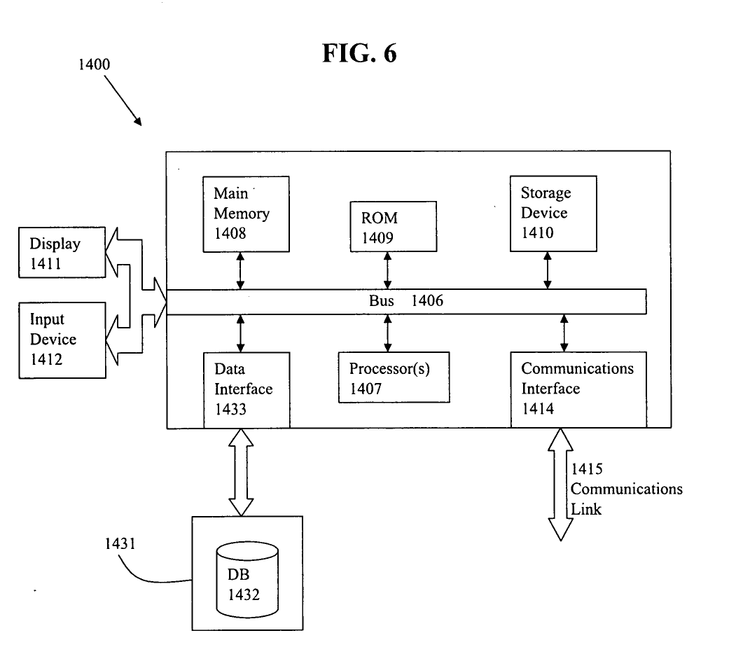

FIG. 6 is a block diagram of an illustrative computing system 1400 suitable for implementing an embodiment of the present invention. Computer system 1400 includes a bus 1406 or other communication mechanism for communicating information, which interconnects subsystems and devices, such as processor 1407, system memory 1408 (e.g., RAM), static storage device 1409 (e.g., ROM), disk drive 1410 (e.g., magnetic or optical), communication interface 1414 (e.g., modem or Ethernet card), display 1411 (e.g., CRT or LCD), input device 1412 (e.g., keyboard), and cursor control.

According to one embodiment of the invention, computer system 1400 performs specific operations by processor 1407 executing one or more sequences of one or more instructions contained in system memory 1408. Such instructions may be read into system memory 1408 from another computer readable/usable medium, such as static storage device 1409 or disk drive 1410. In alternative embodiments, hard-wired circuitry may be used in place of or in combination with software instructions to implement the invention. Thus, embodiments of the invention are not limited to any specific combination of hardware circuitry and/or software. In one embodiment, the term “logic” shall mean any combination of software or hardware that is used to implement all or part of the invention.

The term “computer readable medium” or “computer usable medium” as used herein refers to any medium that participates in providing instructions to processor 1407 for execution. Such a medium may take many forms, including but not limited to, non-volatile media and volatile media. Non-volatile media includes, for example, optical or magnetic disks, such as disk drive 1410. Volatile media includes dynamic memory, such as system memory 1408.

Common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer can read.

In an embodiment of the invention, execution of the sequences of instructions to practice the invention is performed by a single computer system 1400. According to other embodiments of the invention, two or more computer systems 1400 coupled by communication link 1415 (e.g., LAN, PTSN, or wireless network) may perform the sequence of instructions required to practice the invention in coordination with one another.

Computer system 1400 may transmit and receive messages, data, and instructions, including program, i.e., application code, through communication link 1415 and communication interface 1414. Received program code may be executed by processor 1407 as it is received, and/or stored in disk drive 1410, or other non-volatile storage for later execution.

In the foregoing specification, the invention has been described with reference to specific embodiments thereof. It will, however, be evident that various modifications and changes may be made thereto without departing from the broader spirit and scope of the invention. For example, the above-described process flows are described with reference to a particular ordering of process actions. However, the ordering of many of the described process actions may be changed without affecting the scope or operation of the invention. The specification and drawings are, accordingly, to be regarded in an illustrative rather than restrictive sense.

What is claimed is:

1. A computer program product that includes a computer readable medium, the computer readable medium comprising a plurality of computer instructions which, when executed by a processor, cause the processor to execute a process for performing power inference, the process comprising:
dividing an electronic design into multiple design portions;
receiving data input regarding power-related parameters for the multiple design portions of the electronic design;
analyzing the data input to determine whether inference is needed for a power management structure for the multiple design portions of the electronic design;
inferring characteristics of the power management structure based upon analysis of the data input; and
displaying the inferred characteristics of the power management structure on a display device or storing the inferred characteristics of the power management structure in a data structure configured on a computer readable medium.

2. The computer program product of claim 1 in which the inferred characteristics of the power management structure for the electronic design is used for chip planning.

3. The computer program product of claim 1 in which the power management structure inferred for the electronic design comprises a state retention structure, level shifter structure, isolation structure, or power switch structure.

4. The computer program product of claim 3 in which the isolation structure is inferred if a design portion supports power shutoff.

5. The computer program product of claim 3 in which the level shifter structure is inferred if there is a difference in operating voltage between two different design portions.

6. The computer program product of claim 3 in which the power switch structure is inferred if a design portion can be externally controlled.

7. The computer program product of claim 3 in which the state retention structure is inferred if a design portion supports power shutoff and is designated to retain state if power for the design portion is shut off.

8. The computer program product of claim 1 in which the multiple design portions are power domains corresponding to discrete physical portions of the electronic design that share a common power attribute.

9. The computer program product of claim 1 in which at least one of the multiple design portions has a plurality of power modes, where the plurality of power modes comprises a change in voltage between modes.

10. The computer program product of claim 1 in which the data input is analyzed for inference based upon one or more rules, wherein the one or more rules correspond to requirements to infer the power management structure.

11. The computer program product of claim 1 further comprising:
calculating initial area and initial power;
calculating a modification to the initial area based upon the inferred power management structure; and
calculating a modification to the initial power based upon the inferred power management structure.

12. The computer program product of claim 1 further comprising:
visually displaying the inferred characteristics of the power management structure in a graphical user interface.

13. The computer program product of claim 12 in which the graphical user interface permits a user to modify an attribute of the power management structure or provide the data input for the electronic design.

14. A process for performing power inference, the process comprising:
dividing an electronic design into multiple design portions;
receiving data input regarding power-related parameters for the multiple design portions of the electronic design;
analyzing the data input to determine whether inference is needed for a power management structure for the multiple design portions of the electronic design;
inferring characteristics of the power management structure based upon analysis of the data input; and
displaying the inferred characteristics of the power management structure on a display device or storing the inferred characteristics of the power management structure in a data structure configured on a computer readable medium.

15. The process of claim 14 in which the inferred characteristics of the power management structure for the electronic design is used for chip planning.

16. The process of claim 14 in which the power management structure inferred for the electronic design comprises a state retention structure, level shifter structure, isolation structure, or power switch structure.

17. The process of claim 16 in which the isolation structure is inferred if a design portion supports power shutoff.

18. The process of claim 16 in which the level shifter structure is inferred if there is a difference in operating voltage between two different design portions.

19. The process of claim 16 in which the power switch structure is inferred if a design portion can be externally controlled.

20. The process of claim 16 in which the state retention structure is inferred if a design portion supports power shutoff and is designated to retain state if power for the design portion is shut off.

21. The process of claim 14 in which the multiple design portions are power domains corresponding to discrete physical portions of the electronic design that share a common power attribute.

22. The process of claim 14 in which at least one of the multiple design portions has a plurality of power modes, where the plurality of power modes comprises a change in voltage between modes.

23. The process of claim 14 in which the data input is analyzed for inference based upon one or more rules, wherein the one or more rules correspond to requirements to infer the power management structure.

24. The process of claim 14 further comprising:
calculating initial area and initial power;
calculating a modification to the initial area based upon the inferred power management structure; and
calculating a modification to the initial power based upon the inferred power management structure.

25. The process of claim 14 further comprising:
visually displaying the inferred characteristics of the power management structure in a graphical user interface.

26. The process of claim 25 in which the graphical user interface permits a user to modify an attribute of the power management structure or provide the data input for the electronic design.

27. A system for performing power inference, the system comprising:
a computer readable medium comprising a cell library and information about an electronic design;
a power inference tool that receives the cell information and the information about the electronic design to generate inference about a power management structure for the electronic design, wherein the power management structure comprises a cell from the cell library; and
a graphical user interface that displays the electronic design to visually include the power management structure.

28. The system of claim 27 in which the power management structure inferred for the electronic design comprises a state retention structure, level shifter structure, isolation structure, or power switch structure.

29. The system of claim 28 in which the isolation structure is inferred if a design portion supports power shutoff.

30. The system of claim 28 in which the level shifter structure is inferred if there is a difference in operating voltage between two different design portions.

31. The system of claim 28 in which the power switch structure is inferred if a design portion can be externally controlled.

32. The system of claim 28 in which the state retention structure is inferred if a design portion supports power shutoff and is designated to retain state if power for the design portion is shut off.

33. The system of claim 27 in which the electronic design are divided in multiple power domains corresponding to discrete physical portions of the electronic design that share a common power attribute.

34. The system of claim 27 in which the graphical user interface permits a user to modify an attribute of the power management structure or provide the data input for the electronic design.

35. The system of claim 27 in which the power inference tool calculates initial area and initial power, calculates a modification to the initial area based upon the inferred power management structure, and calculates a modification to the initial power based upon the inferred power management structure.
